(19) United States
(12) Patent Application Publication
(10) Pub. No.: US 2025/0309762 A1
(43) Pub. Date: Oct. 2, 2025

(54) MULTI-STAGE SWITCHED CAPACITOR ARCHITECTURE

(71) Applicant: Intel Corporation, Santa Clara, CA (US)

(72) Inventors: Keng Chen, Acton, MA (US); Arvind Raghavan, Lexington, MA (US); Christopher Schaef, San Diego, CA (US); Tamir Salus, Zichron Yaakov (IL); Huanhuan Zhang, Ashland, MA (US); Sivaraman Masilamani, Marietta, GA (US)

(21) Appl. No.: 18/621,900

(22) Filed: Mar. 29, 2024

(51) Int. Cl. H02M 3/07; H02M 3/157

(52) U.S. Cl. CPC H02M 3/07; H02M 3/157

(57) ABSTRACT

Embodiments herein relate to a voltage regulator (VR) circuit which includes first, second and third stages. The first stage VR can operate at a fixed voltage down-conversion ratio to provide an intermediate ground voltage for the second stage VR, which is a continuous capacitive VR (C2VR). The C2VR also receives an input voltage. The third stage VR operates at a voltage down-conversion ratio to provide an output voltage. A set of clock signals with different frequencies is made available to the first stage VR to allow the first stage VR to operate with a peak efficiency according to different stresses placed on the C2VR at different times. The down-conversion ratio of the third stage VR can also be modified during a dynamic bypass mode where the input voltage ramps down to the output voltage.

### BACKGROUND

Computing devices often rely on voltage regulators (VRs) to obtain power. A VR is an electrical circuit which accepts a direct current (DC) input and generates a DC output of a different voltage, usually achieved by high frequency switching of inductive and/or capacitive elements. For example, a power converter can convert the main supply voltage of a computing device, such as 12-48 V, down to lower voltages, such as about 1 V. The lower voltages can be used by various components in the computing device, such as a Universal Serial Bus (USB) interface, memory such as dynamic random access memory (DRAM) and processing resources such as a central processing unit (CPU). However, it is challenging to supply power efficiently.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 depicts an example voltage regulator (VR) circuit 100 having a first stage VR 120, a second stage VR 130 and a third stage VR 140, in accordance with various embodiments.

FIG. 2 depicts an example implementation of the second stage VR 130 of FIG. 1, in accordance with various embodiments.

FIG. 3 depicts an example operation of the second stage VR 130 of FIG. 1, consistent with FIG. 2, in accordance with various embodiments.

FIG. 4A depicts example plots 400 and 401 of switching frequency for the first and second stage VRs, respectively, of FIG. 1, as a load increases over time, with Vout2=0.65 V, in accordance with various embodiments.

FIG. 4B depicts example plots 410 and 411 of output current for the first and second stage VRs, respectively, consistent with FIG. 4A, in accordance with various embodiments.

FIG. 4C depicts example plots 420 and 421 of transient output current for the first and second stage VRs, respectively, consistent with FIG. 4A, in accordance with various embodiments.

FIG. 5A depicts example plots 500 and 501 of switching frequency for the first and second stage VRs, respectively, of FIG. 1, as a load increases over time, with Vout2=1.0 V, in accordance with various embodiments.

FIG. 5B depicts example plots 510 and 511 of output current for the first and second stage VRs, respectively, consistent with FIG. 5A, in accordance with various embodiments.

FIG. 6A depicts example plots 600 and 601 of switching frequency for the first and second stage VRs, respectively, of FIG. 1, as a load increases over time, with Vout2=1.5 V, in accordance with various embodiments.

FIG. 6B depicts example plots 610 and 611 of output current for the first and second stage VRs, respectively, consistent with FIG. 6A, in accordance with various embodiments.

FIG. 7 depicts an example voltage regulator circuit 700 having a clock circuit 715 with a set of dividers 717, a control circuit 705 to select one of the dividers, and the first stage VR 120, the second stage VR 130 and the third stage VR 140 of FIG. 1, in accordance with various embodiments.

FIG. 8 depicts an example implementation of multiple instances 820 of the third stage VR 140 of FIG. 7, and a clock distribution circuit 810 for providing clock signals to the multiple instances, in accordance with various embodiments.

FIG. 9 depicts example plots 900 and 910 of an output voltage of the first and second stages, respectively, of the example voltage regulator circuit 700 of FIG. 7, showing how the output voltage remains substantially constant with different switching frequencies for the first stage VR 120, in accordance with various embodiments.

FIG. 10A depicts an example voltage regulator circuit 1000 having multiple VR cells 1010, 1020, 1030 and 1040, where each cell includes one or more input VRs, a continuous capacitive voltage regulator (C2VR), and an output VR, in accordance with various embodiments.

FIG. 10B depicts an example configuration of the voltage regulator circuit 1000 of FIG. 10A where a subset of the VR cells have their input VRs and their C2VR turned off when a load 145 has a reduced current consumption, in accordance with various embodiments.

FIG. 11 depicts plots of voltages consistent with the circuit 700 of FIG. 7 in a dynamic bypass mode, where the third stage VR has a fixed voltage down-conversion ratio, in accordance with various embodiments.

FIG. 12 depicts plots of voltages consistent with the circuit 700 of FIG. 7 in a dynamic bypass mode, where a voltage down-conversion ratio of the third stage is adjusted, in accordance with various embodiments.

FIG. 13 depicts an example voltage regulator circuit 1300 for adjusting a voltage down-conversion ratio of the third stage in a dynamic bypass mode, consistent with FIG. 12, in accordance with various embodiments.

FIG. 14A depicts plots 1400 and 1410 of a C2VR input and output voltage, respectively, consistent with the circuit 1300 of FIG. 13, where a voltage down-conversion ratio of the third stage is reduced at a time t4, in accordance with various embodiments.

FIG. 14B depicts a close up view of the plots 1400 and 1410 and the ripple 1410r of the plot 1410 of FIG. 14A in the time period Δt, in accordance with various embodiments.

FIG. 15 illustrates an example of components that may be present in a computing system 1550 for implementing the techniques (e.g., operations, processes, methods, and methodologies) described herein.

### DETAILED DESCRIPTION

As mentioned at the outset, various challenges are encountered in efficiently supplying power from a voltage regulator (VR), also referred to as a voltage converter.

For applications with a high input voltage, a VR circuit can have a multi-stage structure where the stages are arranged in series and each stage has a switched-capacitor VR architecture. Each VR receives an input voltage and provides an output voltage by switching according to a clock signal.

A switched-capacitor voltage converter is a type of direct current (DC)-DC converter that uses capacitors and switches to step up or step down an input voltage to a desired output voltage level. Switched capacitor converters rely on the charging and discharging of capacitors to transfer energy. One example is a Continuous Capacitive Voltage Regulator (C2VR), which charges and discharges a capacitor using multiple different voltage rails to provide a continuous voltage output. For flexibility and efficiency, the C2VR can be provided in a multi-stage structure which includes an input VR before the C2VR and an output VR after the C2VR,

However, depending on different engineering purposes, e.g., the range of voltage conversion ratios, and the ability to handle voltage stress, the different stages may use different switched-capacitor architectures. This can result in inefficiencies.

The solutions provided herein address the above and other disadvantages. In one aspect, a VR circuit includes multiple stages including first, second and third stages. The first stage VR can operate at a fixed voltage down-conversion ratio to provide an intermediate ground or supply voltage for the second stage C2VR. The C2VR receives an input voltage Vin which is converted to an output voltage Vout2 for the third stage VR. The third stage VR can operate at a respective voltage down-conversion ratio to provide a final output voltage Vout. A set of clock signals with different frequencies can be made available to the first stage VR to allow the first stage VR to operate with a peak efficiency according to different stresses and current consumption needs of the C2VR at different times. In one aspect, a clock generator provides a clock signal to the second and third stage VRs, and a divided version of the clock signal to the first stage. A set of clock dividers with different division ratios can be coupled to the clock generator, and respective switches coupled to output of respective clock dividers of the set of clock dividers. A control circuit can be provided to select one of the switches to allow the first stage to receive the corresponding divided clock signal.

In an example implementation, the third stage has a selectable voltage down-conversion ratio, and the first stage receives a clock signal which has a frequency which is a decreasing function of the voltage down-conversion ratio. Thus, when the down-conversion ratio is higher, the frequency is lower. A higher down-conversion ratio at the third stage means the second stage has a lower down-conversion ratio, assuming it is in a step down mode, and therefore a higher Vout2, so that there is a reduced need for current from the intermediate ground from the first stage. The step down of the second stage is from Vin to Vout2. The first stage can therefore improve its efficiency by operating at a lower frequency.

In another example implementation, the control circuit determines whether the second stage is operating in a boost mode or step down mode and provides a higher frequency for the divided clock signal when the second stage is operating in the boost mode in the step down mode, as the need for current from the intermediate ground is greater in the boost mode.

In another example implementation, the frequency of the divided clock signal is based on an output voltage of the third stage and/or a ratio between the output voltage and a voltage Vin of an input node. For example, the higher the output voltage, the lower the first stage switching frequency.

In another example implementation, the third stage comprises multiple VR instances, and at least one of the different VR instances is to transition from operating with a gapped version of the clock signal to operating with a non-gapped version of the clock signal as a current of a load increased. The load may be coupled to an output voltage path of the third stage, for example. This approach optimizes the loading configuration between the second and third stages. One first stage and one second stage can load several third stage VRs. At a light load, the third stage VRs can be operated in an interleaved clock pattern until the load becomes heavy enough, at which time the third stage VRs are operated with a common non-gapped clock signal.

In another aspect, a down-conversion ratio of the third stage is decreased when an output voltage of the C2VR ramps down below a first threshold such as in a dynamic bypass mode, where the input voltage ramps down from an initial voltage to the output voltage of the third stage. The C2VR can also transition from a step down mode to a boost mode when the output voltage of the C2VR ramps down below a second threshold, which may be greater than the first threshold. A control circuit may shut off the C2VR and the third stage when the input voltage reaches the output voltage of the third stage. The reduction of the down-conversion ratio of the third stage reduces the stress on the C2VR.

In another aspect, a set of voltage regulator (VR) cells is provided, where each VR cell comprises a continuous capacitive voltage regulator (C2VR), one or more input VRs coupled to an input of the C2VR, and an output VR coupled to an output of the C2VR. A circuit can monitor a current of a load and turn on the input VRs and the C2VRs for a number of the VR cells, wherein the number is an increasing function of the current, while maintaining an on state for each of the output SC VRs. This approach reduces current consumption while still providing the benefit of distributing the output load of a C2VR over multiple output VRs.

The solutions provide a number of benefits. For example, at heavy load conditions, the optimization of the switching frequency of the first stage VR can reduce self-burning power and boost overall efficiency. Additionally, running the first stage with a lower frequency when appropriate optimizes the sizing of the switches in the different VR stages and provides better current density. Moreover, with an optimized voltage conversion ratio at the third stage, the overall efficiency can be improved especially at light load conditions, while ripple is also reduced.

These and other features will be further apparent in view of the following discussion.

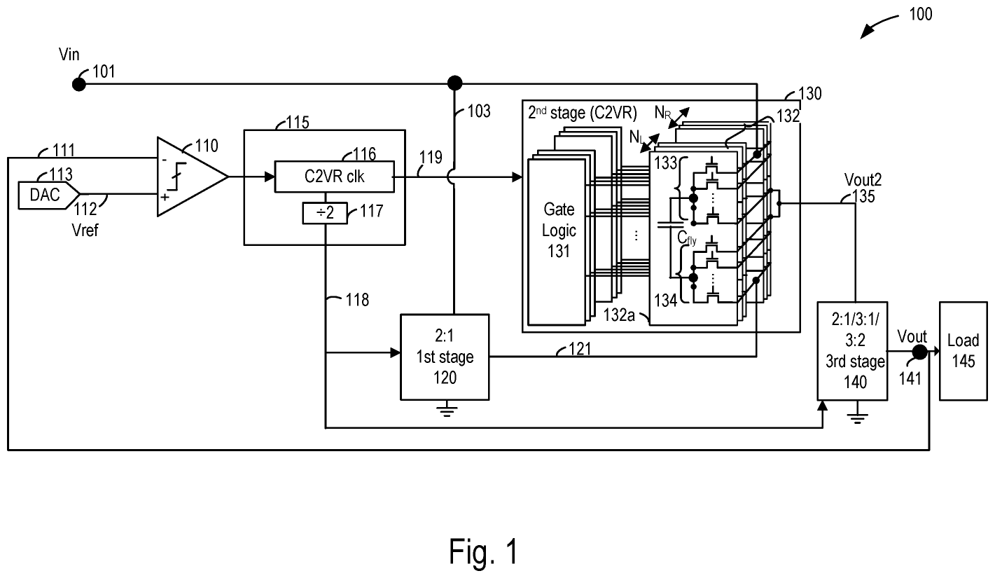

FIG. 1 depicts an example voltage regulator (VR) circuit 100 having a first stage VR 120, a second stage VR 130 and a third stage VR 140, in accordance with various embodiments. The use of three stages is an example, as other implementations can have fewer than three or more than three stages. The VR circuit includes a comparator 110, a clock circuit 115 and first, second and third stage VRs 120, 130 and 140, respectively. The comparator has an inverting input 111 coupled to an output node 141 of the third stage 140, and a non-inverting input 112 to receive a reference voltage Vref which is provided by a digital-to-analog converter (DAC) 113. The input 111 is also a feedback path with Vout from an output node 141, which is coupled to a load 145. The output of the comparator is high when Vout<Vref, causing a clock generator 116 in the clock circuit 115 to generate a baseline clock signal for input on a path 119 to the C2VR, the second stage. The clock signal is also divided in frequency by two at a divider 117 to provide a divided clock signal on a path 118 to the first stage 120. When Vout>Vref, the clock generator stops generating a clock signal.

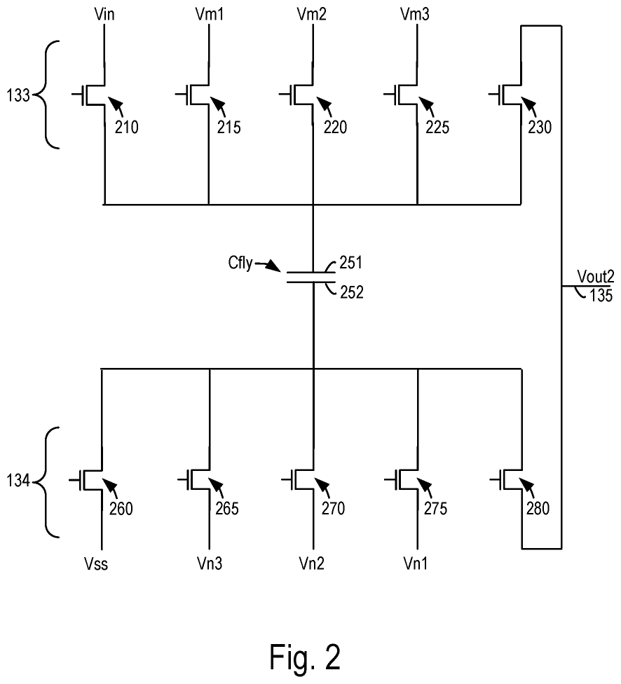

The first stage 120 performs a 2:1 voltage down-conversion on an input voltage Vin in this example to provide an intermediate ground voltage Vin/2 on a path 121 to the C2VR. The intermediate ground voltage is typically a positive voltage. Vin is provided at an input node 101 and on a path 103 to the first stage 120. Vin is also provided to the second stage 130. The second stage 130 includes several gate logic circuits 131 which provide different voltage levels to multiple sets of switches 132. See also FIG. 2. The sets of switches can include a number NL of left-side switches and a number NR of right-side switches. An example set of switches 132a includes a set of transistors 133 coupled to a top plate of a flying capacitor Cfly and a set of transistors 134 coupled to a bottom plate of Cfly. The set of transistors 133 are coupled to voltage rails at Vin, Vm1, Vm2, Vm3 and Vout, and the set of transistors 134 are coupled to voltage rails at Vout, Vn1, Vn2, Vn3 and Vss, for instance.

An output path 135 of the second stage at a voltage Vout2 is input to the third stage. In one approach, the third stage has a selectable voltage down-conversion ratio, e.g., 2:1, 3:1 and 3:2, to down convert Vout2 to provide Vout. The ratio can be programmed by a control circuit, not shown here.

The circuit 100 provides a multi-stage switched-capacitor architecture which is suitable for high input voltage applications. The first stage can be a 2:1 switched-capacitor converter that will provide a ground rail for the second stage switched-capacitor converter, which in turn will be used for a wide conversion ratio regulation. The third stage switched-capacitor converter has a limited conversion ratio, which will regulate the final output voltage based on the output of the second stage converter and the target output voltage.

In this design, due to the differences between the three types of voltage converters, the loading capability is different among these converters. This can result in problems such as a loading mismatch between the first and second stage converters. Specifically, when the overall load is defined, and the third stage conversion ratio has been selected, the second stage converter output current will be fixed over different output voltage settings. However, for the first stage, which provides the ground voltage for the second, the output current varies significantly with different output voltage settings.

The solutions herein provide a clock propagation mechanism which addresses the above and other issues to maintain a high efficiency.

FIG. 2 depicts an example implementation of the second stage VR 130 of FIG. 1, in accordance with various embodiments. The set of transistors 133 includes transistors 210, 215, 220, 225 and 230 coupled to voltage rails Vin, Vm1, Vm2, Vm3 and Vout2, respectively, and to a top plate 251 of a flying capacitor, Cfly. The set of transistors 134 includes transistors 260, 265, 270, 275 and 280 coupled to voltage rails Vss, Vn3, Vn2, Vn3 and Vout2, respectively, and to a bottom plate 252 of Cfly.

While one capacitor, Cfly, is depicted as a charge transfer component, one or more capacitors can be used. The sets of transistors 133 can transfer charge to the top plate 251 and the sets of transistors 134 can transfer charge from the bottom plate 252.

Each transistor receives a respective control gate voltage to turn the transistor on or off to couple or decouple, respectively, the respective voltage rail to the respective side of the capacitor.

The power rails can be at different levels, as mentioned. For example, on the input side, Vin can be the highest power rail, e.g., at a power supply level Vcc, and Vm1-Vm3 can be progressively lower voltages. On the output side, Vn1 can be the highest power rail, e.g., at Vcc, and Vn1-Vss can be progressively lower voltages.

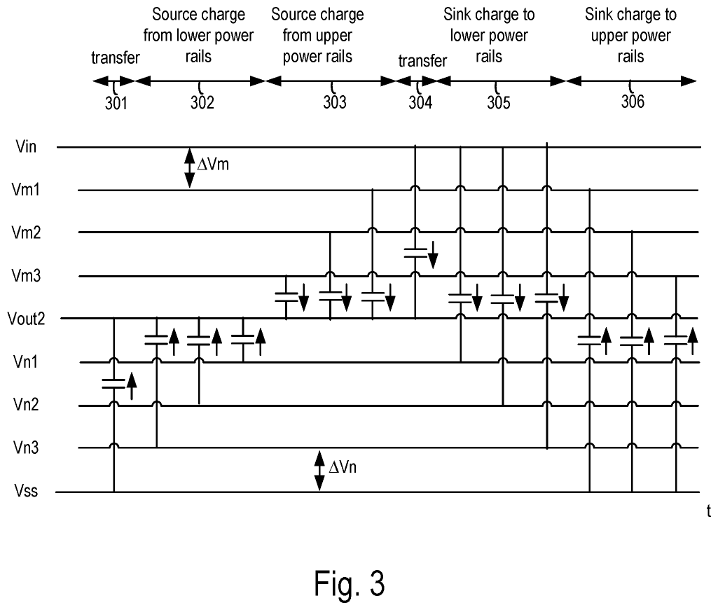

FIG. 3 depicts an example operation of the second stage VR 130 of FIG. 1, consistent with FIG. 2, in accordance with various embodiments. The figure represents a direction of charge transfer to the flying capacitor in the second stage over time (t) and in different phases 301-306 in a step down mode of the VR. The voltages of the upper and lower power rails are separated by increments of ΔVm and ΔVn, respectively.

A phase 301 represents a regular transfer with the bottom plate at Vss and the top plate at Vout2. A phase 302 represents sourcing charge from the lower power rails with the top plate at Vout2 and the bottom plate in a sequence of Vn3, Vn2 and Vn1. A phase 303 represents sourcing charge from the upper power rails with the bottom plate at Vout2 and the top plate in a sequence of Vm3, Vm2 and Vm1. A phase 304 represents another regular transfer with the top plate at Vin and the bottom plate at Vout2. A phase 305 represents sinking charge to the lower power rails with the top plate at Vin and the bottom plate in a sequence of Vn1, Vn2 and Vn3. A phase 306 represents sinking charge to the upper power rails with the lower plate at Vss and the top plate in a sequence of Vm1, Vm2 and Vm3.

Generally, the higher the output voltage of the second stage, the lower the current required from the Vss rail which is provided as the intermediate ground voltage by the first stage. The higher output voltage of the second stage corresponds to a smaller step down conversion of the second stage. By reducing the clock frequency of the first stage when the output voltage of the second stage is relatively high, the first stage can reduce its power consumption.

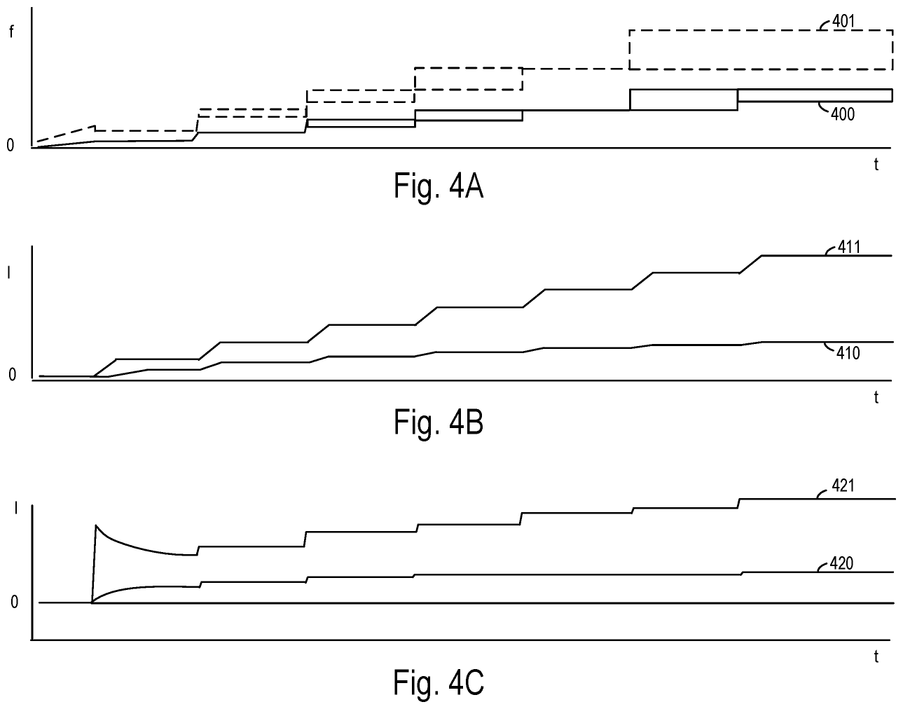

FIG. 4A depicts example plots 400 and 401 of switching frequency for the first and second stage VRs, respectively, of FIG. 1, as a load increases over time, with Vout2=0.65 V, in accordance with various embodiments. Vout2 is the output voltage of the second stage. The plots include bounding boxes which show a range of noise on the frequency signals in a simplified way. The switching frequency increases as the load increases. In the example of FIG. 1, a divider divides the clock frequency in half, so that the maximum frequency of the plot 401 is about double the frequency of the plot 400, e.g., 250 MHz vs. 125 MHZ.

FIG. 4B depicts example plots 410 and 411 of output current for the first and second stage VRs, respectively, consistent with FIG. 4A, in accordance with various embodiments. The output current is measured using a current controlled voltage source. As an example, the output current reaches a maximum of about 100 mV or 100 mA with 1V=1A for the plot 410, and about 350 mA for the plot 411.

FIG. 4C depicts example plots 420 and 421 of transient output current for the first and second stage VRs, respectively, consistent with FIG. 4A, in accordance with various embodiments. As an example, the output current reaches a maximum of about 160 mA for the plot 420, and about 550 mA for the plot 421.

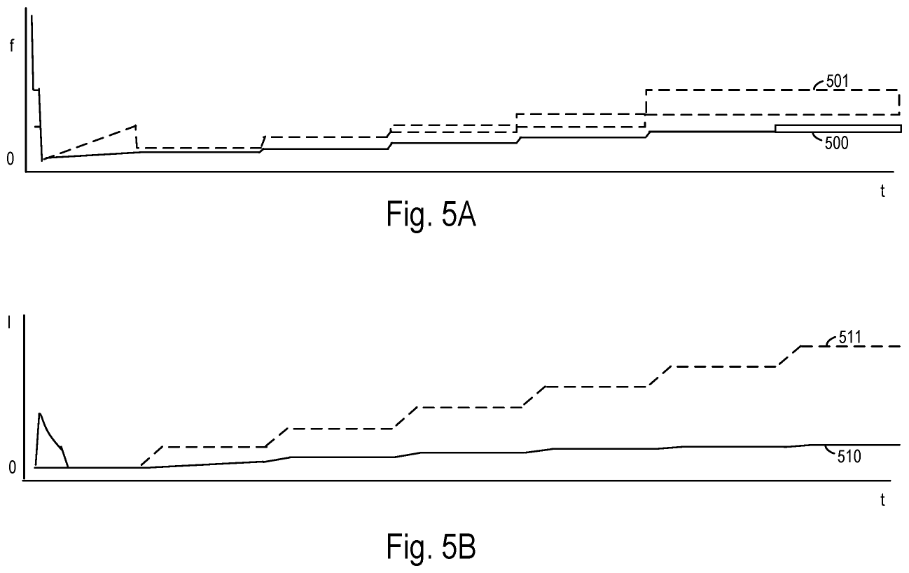

FIG. 5A depicts example plots 500 and 501 of switching frequency for the first and second stage VRs, respectively, of FIG. 1, as a load increases over time, with Vout2=1.0 V, in accordance with various embodiments. As in FIG. 4A, the maximum frequency of the plot 501 is about double the frequency of the plot 500, e.g., 250 MHz vs. 125 MHZ.

FIG. 5B depicts example plots 510 and 511 of output current for the first and second stage VRs, respectively, consistent with FIG. 5A, in accordance with various embodiments. As an example, the output current reaches a maximum of about 55 mA for the plot 510, and about 300 mA for the plot 511.

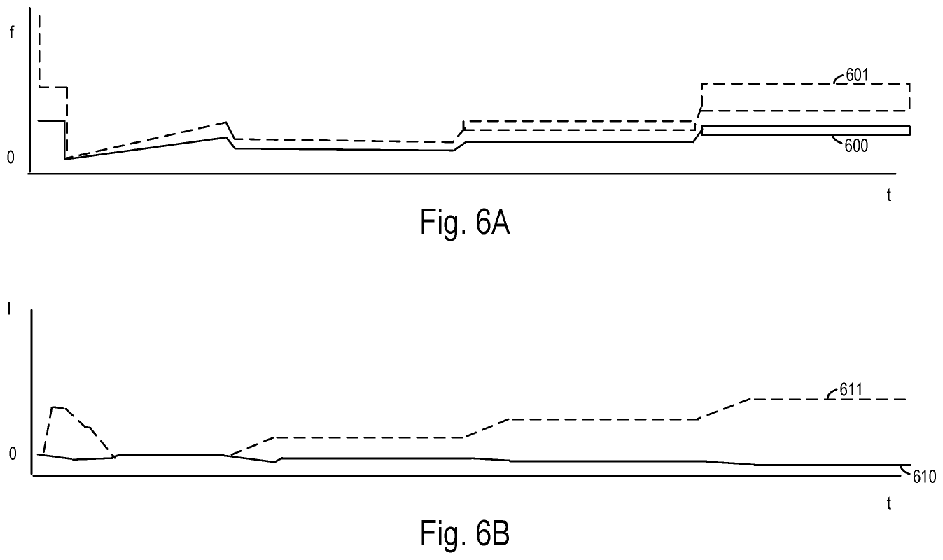

FIG. 6A depicts example plots 600 and 601 of switching frequency for the first and second stage VRs, respectively, of FIG. 1, as a load increases over time, with Vout2=1.5 V, in accordance with various embodiments. The maximum frequency of the plot 601 is about double the frequency of the plot 600, e.g., 200 MHz vs. 100 MHz. The switching frequency is lower than in FIGS. 4A and 5A since Vout2 is relatively higher.

FIG. 6B depicts example plots 610 and 611 of output current for the first and second stage VRs, respectively, consistent with FIG. 6A, in accordance with various embodiments. As an example, the output current is about-21 mA for the plot 610, and reaches a maximum of about 150 mA for the plot 511.

Accordingly, with Vout2=0.65 V, 1.0 V or 1.5 V, the required output current of the first stage is 100 mA, 55 mA or −21 mA, respectively. The required output current is thus a decreasing function of Vout2, e.g., the current decreases as the voltage increases. Accordingly, a reduced clock frequency can be used for the first stage when the required output current is reduced and Vout2 is higher. Further, Vout2 can be related to Vout by the conversion ratio of the third stage. Accordingly, a reduced clock frequency can be used for the first stage when Vout2 and Vout are higher. A reduced clock frequency can be used for the first stage as Vout increases and/or as a ratio between the output voltage and a voltage of the input node (Vout/Vin) increases.

A control circuit can detect Vout2 and/or Vout and select one of the divided clock frequencies for use by the first stage accordingly.

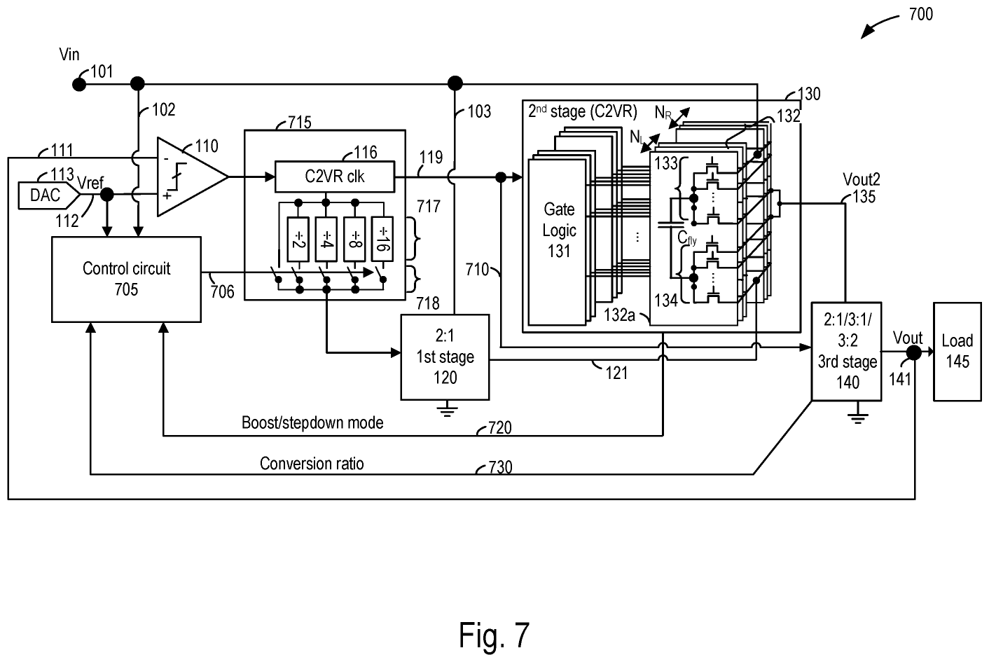

FIG. 7 depicts an example voltage regulator circuit 700 having a clock circuit 715 with a set of dividers 717, a control circuit 705 to select one of the dividers, and the first stage VR 120, the second stage VR 130 and the third stage VR 140 of FIG. 1, in accordance with various embodiments. The circuit 700 includes a clock circuit 715 which includes the clock generator 116, a set of dividers 717 and a corresponding set of switches 718, one switch per divider, for example. In this example, there are four dividers with division ratios of 2, 4, 8 and 16. Other configurations are possible. A control circuit 705 can provide a control or select signal on a path 706 to select one of the switches and pass the corresponding divided clock signal to the first stage 120. The first stage receives Vin on the path 103 and down converts it to output the intermediate ground voltage on the path 121 to the second stage, using a voltage conversion ratio such as 2:1.

The second and third stages receive the undivided clock signal from the clock generator 116 on paths 119 and 710, respectively. This is in contrast to FIG. 1, where the first and third stages receive the divided clock signal.

A path 720 is coupled to the control circuit and the second stage to allow the control circuit to receive information about whether the second stage is in a boost mode (where Vout2>Vin) or a step down mode (where Vout2<Vin). The control circuit can use this information to select a divided clock signal. A path 730 is coupled between the control circuit and the second stage to allow the control circuit to receive information about the voltage conversion ratio which is currently set in the third stage. The control circuit can use this information to select a divided clock signal.

The control circuit can use the input-output ratio of the VR circuit 700, e.g., the ratio of Vin to Vout, and/or the voltage conversion ratio of the third stage, the ratio of Vout2 to Vout, to select a divided clock frequency for the first stage. Generally, the higher the output voltage, the lower the first stage switching frequency for optimal efficiency.

The control circuit can be implemented using any software, firmware and/or hardware. In an example implementation, the control circuit comprises a memory to store instructions and a processor to execute the instructions to provide the functions described herein.

In an example implementation, the VR circuit 700 includes a clock generator 116 to provide a baseline clock signal, a set of clock dividers 717 with different division ratios coupled to the clock generator, and respective switches 718 coupled to an output of respective clock dividers of the set of clock dividers. The VR circuit further includes a first stage voltage regulator (VR) 120 coupled to the respective switches, a second stage VR 130 coupled to an output of the clock generator, wherein the second stage VR comprises a continuous capacitive VR, a third stage VR 140 coupled to the output of the clock generator, and a circuit 705 coupled to the third stage VR. The circuit 705 is coupled to the respective switches to select one of the respective switches, and the first stage VR is to receive a divided clock from one of the clock dividers based on the selected one of the respective switches.

In one approach, the circuit 705 is to select the one of the respective switches based on a selectable voltage down-conversion ratio of the third stage VR, and a frequency of the divided clock signal is a decreasing function of the selectable voltage down-conversion ratio.

In one approach, the circuit is to select the one of the respective switches to provide a higher frequency for the divided clock signal when the second stage VR is operating in a boost mode than when the second stage VR is operating in a step down mode.

In one approach, the circuit is to select the one of the respective switches based on a ratio between the output voltage Vout and a voltage Vin of the input node.

In one approach, the circuit is to select the one of the respective switches to reduce a frequency of the divided clock as an output voltage of the third stage VR increases.

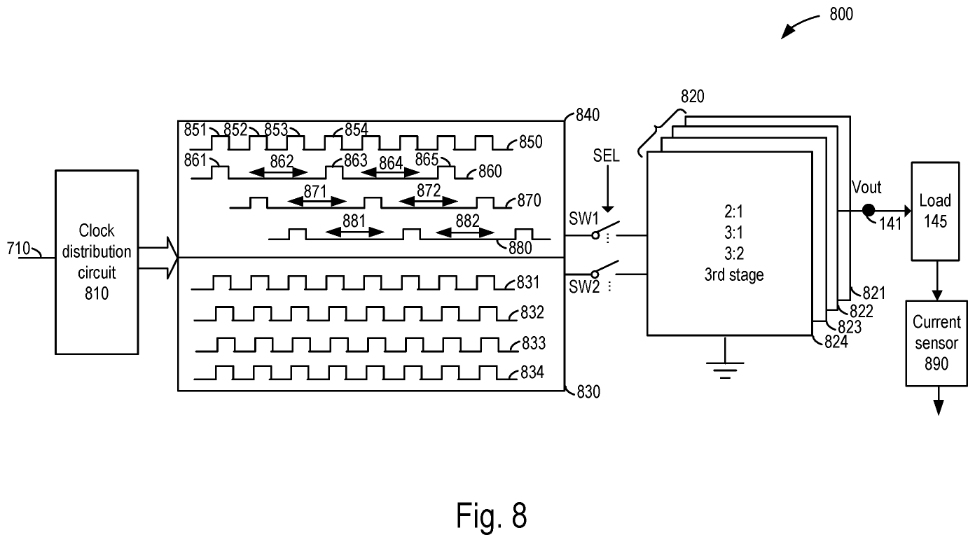

FIG. 8 depicts an example implementation of multiple instances 820 of the third stage VR 140 of FIG. 7, and a clock distribution circuit 810 for providing clock signals to the multiple instances, in accordance with various embodiments. The clock distribution circuit 810 receives the undivided clock signal on the path 710, and outputs a number of clocks for use by the multiple instances 820 of the third stage VR 140. A first set 830 of the clocks includes repeated, time-aligned versions 831-834 of the undivided clock signal. These versions of the clock signal are also referred to as non-gapped versions of the clock signal since the pulses are provided at fixed intervals in a pulse train without missing pulses or gaps in the pulse train. When a set of switches SW2 is selected by a select (SEL) signal, these versions of the clock signal are provided to the multiple instances of the third stage VR, one clock signal per instance. For example, clock signals 831, 832, 833 and 834 can be provided to instances 821, 822, 823 and 824, respectively. Each instance may operate with the same voltage conversion ratio, in one approach.

A second set 840 of the clocks includes a non-gapped version 850 and gapped, time-shifted versions 860, 870 and 880 of the undivided clock signal. For example, the version 850 is the same as the versions 831-834 and includes consecutive pulses at fixed intervals including pulses 851-854. The gapped versions include a gap of two consecutive pulses out of four consecutive pulses as an example. For example, the gapped version 860 includes a first pulse 861, a gap 862 of two pulses (e.g., corresponding to pulse 852 and 853), a second pulse 863, another gap 864 of two pulses and a third pulse 865. The gapped version 870 includes gaps 871 and 872 which are offset by one pulse compared to the gaps 862 and 864. The gapped version 880 includes gaps 881 and 882 which are offset by one pulse compared to the gaps 871 and 872. When a set of switches SW1 is selected by the select (SEL) signal, the non-gapped version and the gapped versions of the clock signal are provided to the multiple instances of the third stage VR, one clock signal per instance. For example, clock signals 850, 860, 870 and 870 can be provided to instances 821, 822, 823 and 824, respectively. In another option, the non-gapped version 850 is replaced by a gapped version so that the second set 840 of the clocks includes all gapped clock signals.

Since each pulse of a clock signal causes the third stage VR to transfer charge, the gaps of the second set 840 of the clocks will result in a reduced amount of charge transfer and a lower output current. This can be appropriate when the current consumption of the load is reduced. When the current consumption of the load is relatively high, the non-gapped clocks can be provided. A current sensor 890 can optionally be used to sense a current consumption of the load. The current sensor can optionally be part of the control circuit and/or third stage. The control circuit can use this information to set the SEL signal. For example, SW1 may be selected if the current consumption is below a threshold and SW2 may be selected if the current consumption is above the threshold.

By providing multiple third stage converters which can be coupled to a common first and second stage converter, a loading mismatch is avoided between the second and third stage converters. A loading mismatch and a corresponding waste of energy would occur if separate third stages were coupled to separate first and second stages, for example, especially under light load conditions. Instead, here, one first and second stage can be used to load several third stage converters.

In an example implementation, the third stage VR has different VR instances 821-824, and at least one of the different VR instances 822, 823 or 824 is to transition from operating with a gapped version of the clock signal 860, 870 or 880 to operating with a non-gapped version of the clock signal 832, 833 or 834 as a current of a load which is coupled to an output voltage path of the third stage increases. Moreover, at least one other of the different VR instances 821 continues to operate with a non-gapped version of the clock signal 850 and 831 as the current of the load which is coupled to the output voltage path of the third stage increases.

In an example implementation, a VR circuit 800 includes a clock generator 715 to provide a baseline clock signal, a clock distribution circuit 810 coupled to the clock generator, a first stage voltage regulator (VR) 120 coupled to the clock generator, a second stage VR 130 coupled to the clock generator, wherein the second stage VR comprises a continuous capacitive VR, and a third stage VR 820 coupled to the clock distribution circuit, wherein the third stage VR has different VR instances 821-824, and at least one of the different VR instances is to transition from operating with a gapped version of the baseline clock signal 860, 870 or 880 from the clock distribution circuit to operating with a non-gapped version of the baseline clock signal 831-834 from the clock distribution circuit when a current of a load 145 which is coupled to an output voltage path of the third stage exceeds a threshold. Additionally, at least one other of the different VR instances continues to operate with a non-gapped version of the baseline clock signal 850, 831-834 from the clock distribution circuit as the current of the load which is coupled to the output voltage path of the third stage exceeds the threshold.

In another example implementation, a system comprises: a processor; and a voltage regulator coupled to the processor. The voltage regulator comprises: a clock generator to provide a baseline clock signal, a set of clock dividers with different division ratios coupled to the clock generator, and respective switches coupled to an output of respective clock dividers of the set of clock dividers; a first stage voltage regulator (VR) coupled to the respective switches; a second stage VR coupled to an output of the clock generator, wherein the second stage VR comprises a continuous capacitive VR; a third stage VR coupled to the output of the clock generator; and a circuit coupled to the third stage VR, wherein the circuit is coupled to the respective switches to select one of the respective switches, and the first stage VR is to receive a divided clock from one of the clock dividers based on the selected one of the respective switches.

In another example implementation, a system comprises: a processor; and a voltage regulator circuit coupled to the processor. The voltage regulator circuit comprises: a continuous capacitive voltage regulator (C2VR) to receive an input voltage from an input node; a voltage regulator (VR) to receive an output voltage from the C2VR, wherein the VR is to output an output voltage according to the output voltage from the C2VR and a voltage down-conversion ratio of the VR; and a circuit coupled to the input node and to the VR, wherein the circuit is to decrease the voltage down-conversion ratio of the VR when the input voltage ramps down below a first threshold.

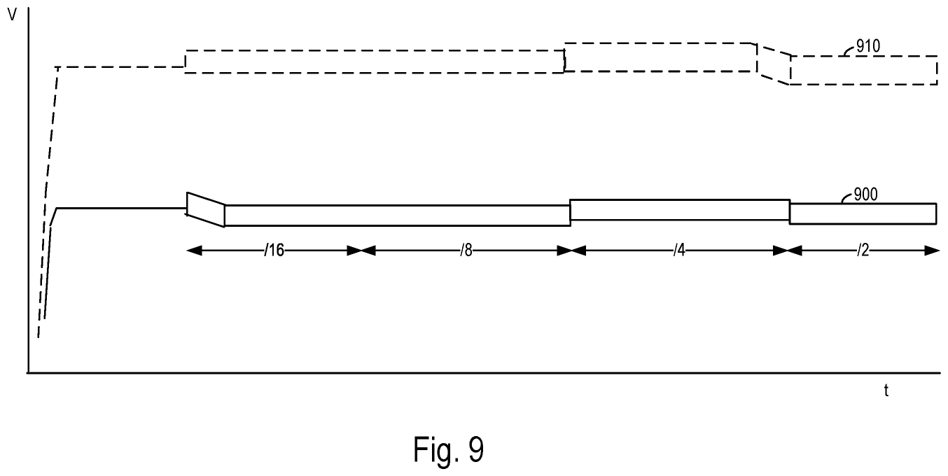

FIG. 9 depicts example plots 900 and 910 of an output voltage of the first and second stages, respectively, of the example voltage regulator circuit 700 of FIG. 7, showing how the output voltage remains substantially constant with different switching frequencies for the first stage VR 120, in accordance with various embodiments. The different switching frequencies correspond to dividing the original clock signal output by the clock generator by 16, 8, 4 and 2. The output voltages remain essentially stable. This demonstrates that adjusting the switching frequency of the VR circuit does not impair its performance. Ripple is also well-controlled.

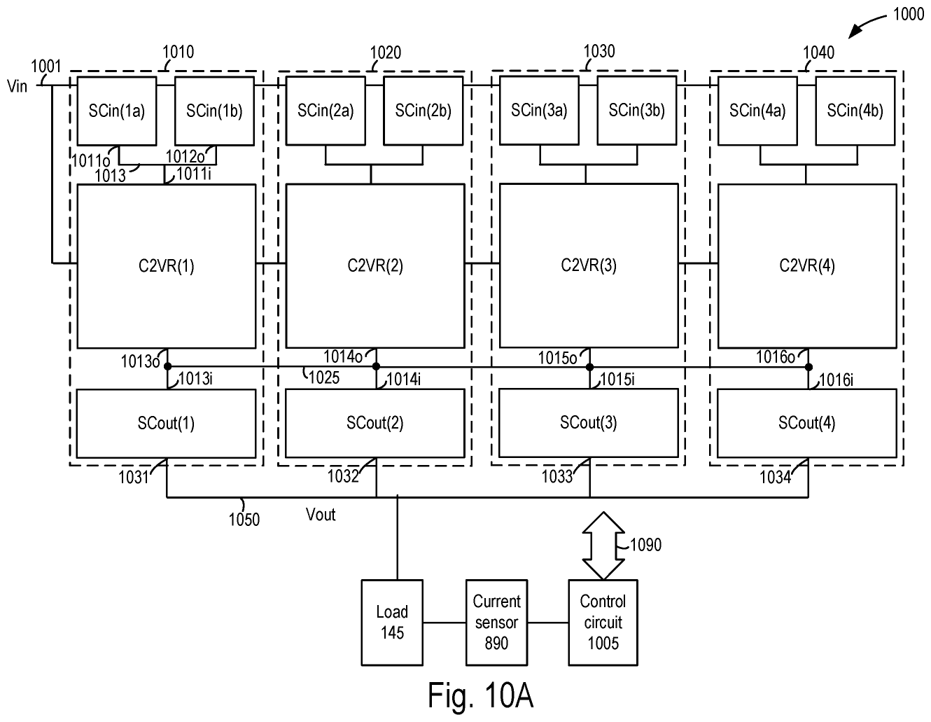

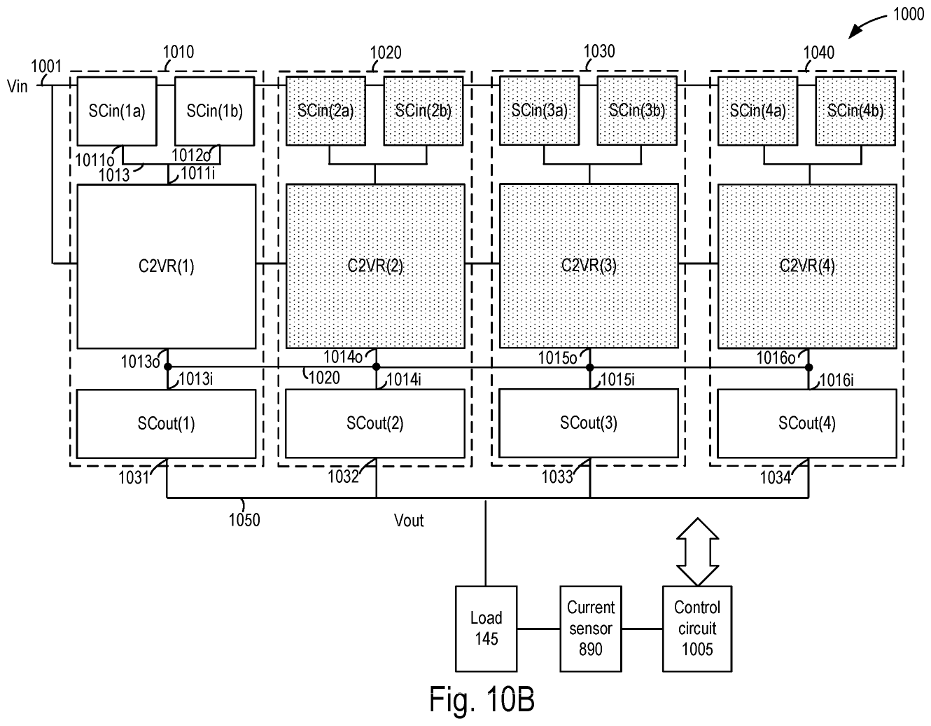

FIG. 10A depicts an example voltage regulator circuit 1000 having multiple VR cells 1010, 1020, 1030 and 1040, where each cell includes one or more input VRs, a continuous capacitive voltage regulator (C2VR), and an output VR, in accordance with various embodiments. This approach can provide flexibility and power savings in delivering current to the load by allowing a portion of the VR circuit to be shut down or depowered when it is not needed. For example, the current sensor 890 can sense the current consumption of the load 145. The control circuit 1005 can use this information to shut down a portion of the VR circuit 1000, such as shown in FIG. 10B, via control paths represented by an arrow 1090.

The VR circuit 1000 includes multiple VR cells 1010, 1020, 1030 and 1040, e.g., four cells or units in this example but generally two or more cells can be used. Each cell can have a similar configuration which in this example includes, for each cell, one or more input VRs, e.g., two input VRs, coupled to an input of a C2VR. The outputs of the C2VRs of the different cells are coupled to an intermediate voltage path 1025 which in turn is coupled to a set of output VRs. One or more output VRs per cell can be used but this example has one output VR per cell. The outputs of the output VRs are coupled to a common output voltage path 1050 which is coupled to the load 145.

The input VRs of the set of cells receive Vin at an input node 1001. The input VRs include SCin(1a) and SCin(1b) for the cell 1010, SCin(2a) and SCin(2b) for the cell 1020, SCin(3a) and SCin(3b) for the cell 1030, and SCin(4a) and SCin(4b) for the cell 1040. Within a cell, the input VRs provide an output which is input to a respective C2VR. For example, for the cell 1010, the input VRs SCin(1a) and SCin(1b) have outputs 10110 and 10120, respectively, which are combined on a path 1013 and provided at an input 1011i of C2VR(1). For the cell 1020, the input VRs SCin(2a) and SCin(2b) have outputs which are combined and provided at an input of C2VR(2). For the cell 1030, the input VRs SCin(3a) and SCin(3b) have outputs which are combined and provided at an input of C2VR(3). For the cell 1040, the input VRs SCin(4a) and SCin(4b) have outputs which are combined and provided at an input of C2VR(4).

The C2VRs operate in a boost or step down mode to increase or decrease, respectively, the input voltage, and provide a respective output voltage Vout2. For example, C2VR(1), C2VR(2), C2VR(3) and C2VR(4) have outputs 10130, 10140, 10150 and 10160, respectively, which are coupled to the intermediate voltage path 1025. The intermediate voltage path 1025 is coupled to inputs 1013i, 1014i, 1015i and 1016i of each of the output VRs, Scout(1), Scout(2), Scout(3) and Scout(4), respectively. The outputs 1031, 1032, 1033 and 1034 of Scout(1), Scout(2), Scout(3) and Scout(4), respectively, are coupled to an output voltage path 1050 to provide Vout to the load 145.

In this example, each of the cells is turned on so that each cell contributes to Vout.

Note that while switched-capacitor VRs are depicted, other types of VRs could be used.

FIG. 10B depicts an example configuration of the voltage regulator circuit 1000 of FIG. 10A where a subset of the VR cells have their input VRs and their C2VR turned off when a load 145 has a reduced current consumption, in accordance with various embodiments. When the current sensor indicates the current consumption of the load is relatively small, the input VR and C2VR of a subset of the cells can be turned off to save power. For example, switches can be used to disconnect Vin or other power supply from the input VR and C2VR and/or no clock signal can be provide tothe input VR and C2VR. The output VRs can be kept powered on, however, to allow the output VRs to share in providing the output voltage. In this example, the shading of the input VR and C2VR of the cells 1020, 1030 and 1040 indicate these components are turned off, while all the VRs of the cell 1010 remain powered, and all the output VRs, including the output VRs Scout(1), Scout(2), Scout(3) and Scout(4) remain powered.

In one approach, the control circuit 1005 can compare the sensed current to three thresholds, Th1, Th2 and Th3, where Th1>Th2>Th3. If the senses current is relatively high and greater than Th1, each of the cells can remain turned on. If the sense current is moderate and between Th1 and Th2, the input VR and C2VR of one of the cells can be turned off while the input VR and C2VR of three remaining cells remain turned on. If the sense current is relatively low and between Th2 and Th3, the input VR and C2VR of two of the cells can be turned off while the input VR and C2VR of two remaining cells remain turned on. If the sense current is very low and below Th3, the input VR and C2VR of three of the cells can be turned off while the input VR and C2VR of one remaining cell remains turned on.

In one approach, the control circuit 1005 is to turn on the input VRs and the C2VRs for a number of the VR cells, wherein the number is an increasing function of the current, while maintaining an on state for each of the output VRs.

The configuration shown has benefits such as reduced ripple and improved efficiency.

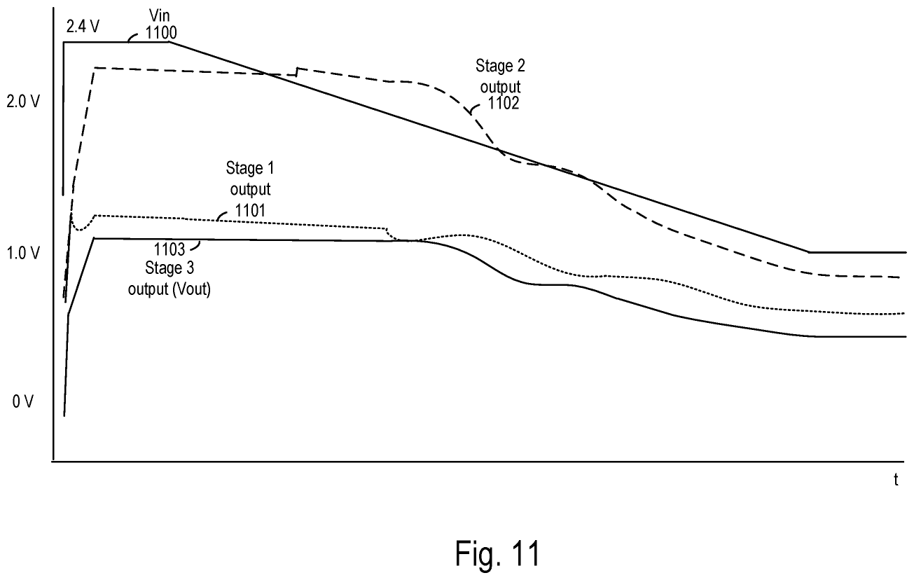

FIG. 11 depicts plots of voltages consistent with the circuit 700 of FIG. 7 in a dynamic bypass mode, where the third stage VR has a fixed voltage down-conversion ratio, in accordance with various embodiments. In a dynamic bypass mode, the input voltage ramps down from an initial voltage to the output voltage, e.g., the output voltage Vout of the third stage. The plots 1100, 1101, 1102 and 1103 represent Vin, the first stage output voltage, the second stage (C2VR) output voltage, and the third stage output voltage (Vout), respectively. Initially, Vin is at a value such as 2.4 V and the first stage output is about 1.2 V, due to the 2:1 down-conversion of the first stage. As the input voltage starts to ramp down toward the output voltage of 1.0 V, the second stage cannot maintain the regulated voltage in the step down mode. This leads to a crash, or uncontrolled decrease, in Vout, which can potentially damage a processor or other load.

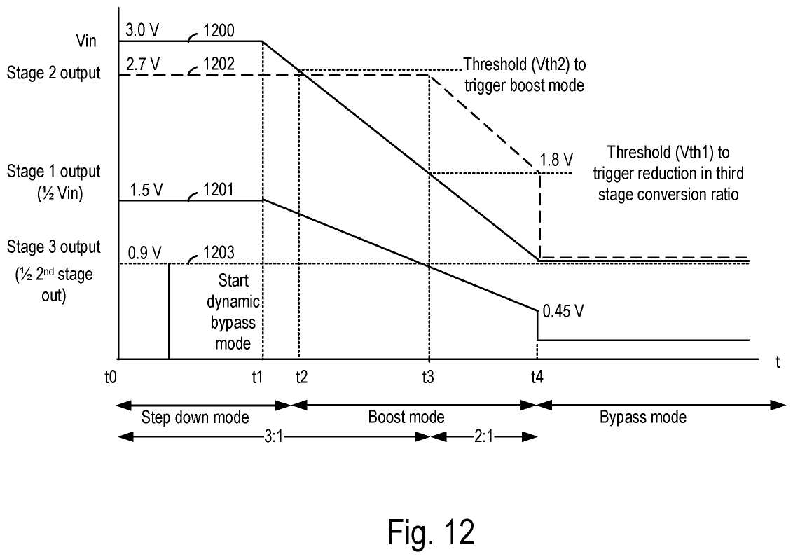

FIG. 12 depicts plots of voltages consistent with the circuit 700 of FIG. 7 in a dynamic bypass mode, where a voltage down-conversion ratio of the third stage is adjusted, in accordance with various embodiments. As mentioned, the dynamic bypass mode can involve Vin ramping down from an initial level to Vout. When Vin reaches Vout, the second and third stages can be turned off, e.g., bypassed, since they are not need to boost or step down Vin. Additionally, during the dynamic bypass mode, the second stage can transition from a step down mode to a boost mode, and the voltage down-conversion ratio of the third stage can be changed, e.g., reduced, to provide an efficient and controlled decrease in Vin while Vout remains stable, unlike the scenario in FIG. 11.

The plots extend over a time period which includes a step down mode from t0-t2, a boost mode from t2-t4, and a bypass mode starting at t4. From t0-t1, Vin and the first, second and third stage output voltages are represented by plots 1200, 1201, 1202 and 1203, respectively. As an example, at t0-t1, Vin(initial)=3.0, the first stage output=1.5 V with a 2:1 down-conversion, Vout=0.9 V (a regulated output voltage based on Vref=0.9 V) and the second stage output=2.7 V due to a 3:1 down-conversion ratio of the third stage. The dynamic bypass mode begins at t1 with the ramping down of Vin, e.g., at a constant rate. At t2, Vin falls below a second threshold Vth2 to trigger the boost mode, so that the boost mode occurs from t2-t4. Vth2 can correspond to the point at which Vin falls below the second stage output, in one approach. Vth2 can be determined based on tests which show a correlation between the second stage output and Vin with a given third stage conversion ratio. In another approach, the second stage output is sensed and compared to Vin at a control circuit to trigger the boost mode.

At t3, Vin falls below a first threshold Vth1 to trigger a reduction in the third stage conversion ratio. For example, the conversion ratio may change from 3:1 to 2:1, causing the second stage output to transition from 2.7 (3×0.9 V) at t3 to 1.8 V (2×0.9 V) at t4. At t4, the bypass mode starts so that the second and third stages are turned off. The first stage output falls to 0.45 V at t4, which is half of Vin at 0.9 V. Optionally, the first stage can also be turned off.

The thresholds Vth1 and Vth2 can vary. For example, Vth2 may be set a certain ΔV below Vin or as a certain percent of Vin(initial) or of Vin(initial)-Vout, e.g., 90%. Vth1 can be set at a level which is between Vout and the initial level of Vin. Note that at t2-t3, as Vin falls, the second stage is under increasing stress to boost Vin up to Vout2=Vout x conversion ratio of third stage. Accordingly, Vth1 should be set to minimize the time of, or avoid, this stress.

The thresholds, especially Vth1, can vary based on the initial down-conversion ratio of the third stage. For example, with a lower initial down-conversion ratio at the start of the dynamic bypass mode, Vout2 can be allowed to fall to a lower level before the second stage is stressed in the boost mode, so that Vth1 can be lower.

As an alternative, the control circuit can compare Vout2 to a respective threshold to decide when to reduce the down-conversion ratio of the third stage.

Generally, when the input voltage starts to drop in the dynamic bypass mode, the second stage will try to maintain its output voltage Vout2 by adjusting its step-down-conversion ratio. However, as the input voltage and floating ground from the first stage keep dropping, the step-down-conversion ratio cannot be maintained. The second stage will change to the boost mode to maintain Vout2. Before the input voltage reaches Vout, the boost conversion ratio for the second stage will keep increasing unless the down conversion ratio of the third stage is reduced.

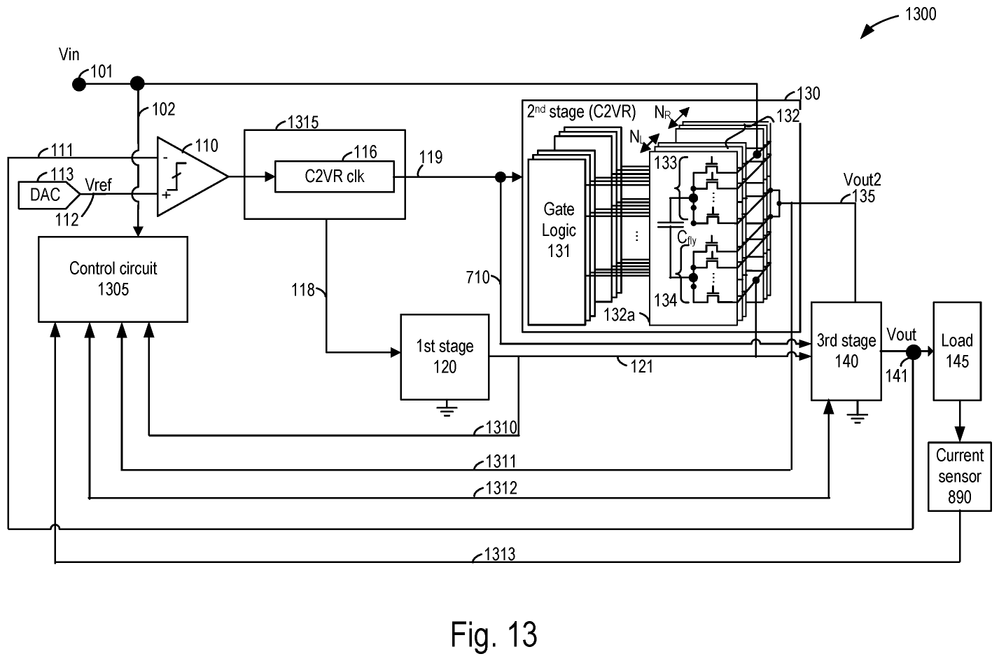

FIG. 13 depicts an example voltage regulator circuit 1300 for adjusting a voltage down-conversion ratio of the third stage in a dynamic bypass mode, consistent with FIG. 12, in accordance with various embodiments. The clock generator circuit 1315 includes the clock generator 116 to provide an undivided or baseline clock signal to the second and third stages. Optionally, a divided clock signal can be provided to the second stage. A control circuit 1305 can receive information from a number of components. For example, a path 1310 can be used to receive the voltage output of the first stage. A path 1311 can be used to receive Vout2 from the second stage. A path 1312 can be used to determine and/or set a voltage conversion ratio of the third stage. A path 1313 can be used to obtain a sensed current of the load from the current sensor 890. The control circuit 1305 can determine whether the load is in a light, medium or heavy load condition based on the sensed current. The path 102 provides Vin to the control circuit.

The control circuit 1305 can monitor and control the status of the VR circuit 1300 in various ways. For example, consistent with FIG. 12, the control circuit can monitor Vin to determine whether it falls below Vth1 and to respond by sending a command to the third stage to change the down-conversion ratio.

In one approach, the control circuit determines the input/output voltage ratio (Vin/Vout2) of the second stage. When the input voltage drops within a certain range of the output voltage, where Vin>Vout2, the second stage enters the boost mode to keep the output voltage unchanged. When the input voltage keeps decreasing, if the conversion ratio for the second stage becomes too high to maintain, the third stage changes its down-conversion ratio to reduce the voltage stress on the second stage. The down-conversion ratio of the third stage could also be used in determining when the second stage enters the boost mode.

This approach helps the circuit meet the voltage stress requirement of the currently used process technology node.

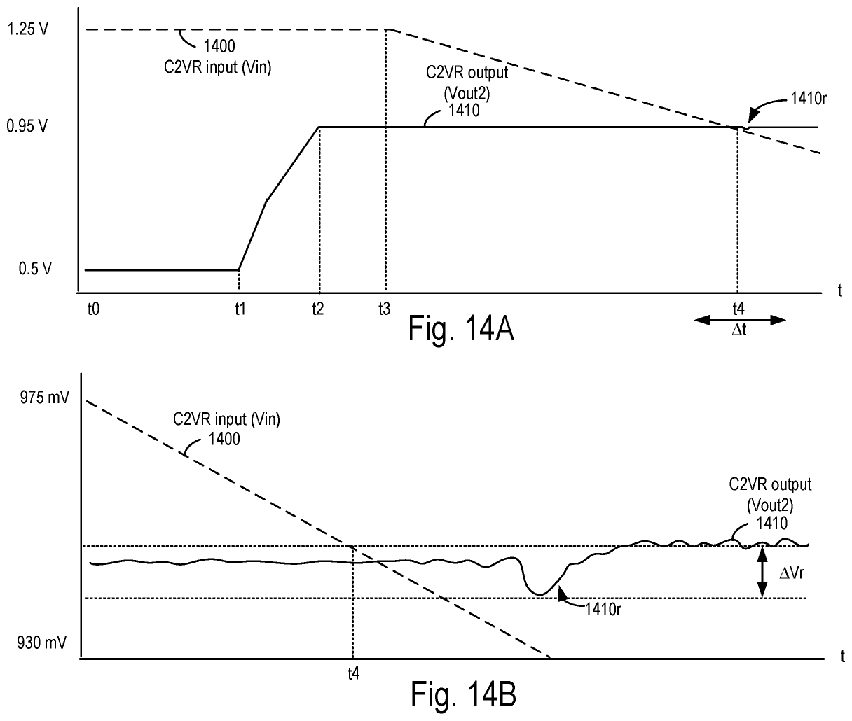

FIG. 14A depicts plots 1400 and 1410 of a C2VR input and output voltage, respectively, consistent with the circuit 1300 of FIG. 13, where a voltage down-conversion ratio of the third stage is reduced at a time t4, in accordance with various embodiments. In this example, Vin is initially at 1.25 V at t0-t3, and Vout2 increases from 0.5 V to 0.95 V. At t3-t4, Vout2 remains steady at 0.95 V even as Vin begins to ramp down, at the start of the dynamic bypass mode. At t4, Vin falls below Vout2, and the down-conversion ratio of the third stage is reduced. This change in the ratio results in only a small ripple 1410r in Vout2. The time period Δt is depicted in more detail in FIG. 14B.

FIG. 14B depicts a close up view of the plots 1400 and 1410 and the ripple 1410r of the plot 1410 of FIG. 14A in the time period Δt, in accordance with various embodiments. As in FIG. 14A, at t4, Vin falls below Vout2, and the down-conversion ratio of the third stage is reduced. This change in the down-conversion ratio results in the ripple 1410r in Vout2 which extends in a range AVr of, e.g., about 8 mV. This demonstrates that the reduction of the down-conversion ratio of the third stage does not result in a significant ripple in Vout2 so that the output Vout remains stable.

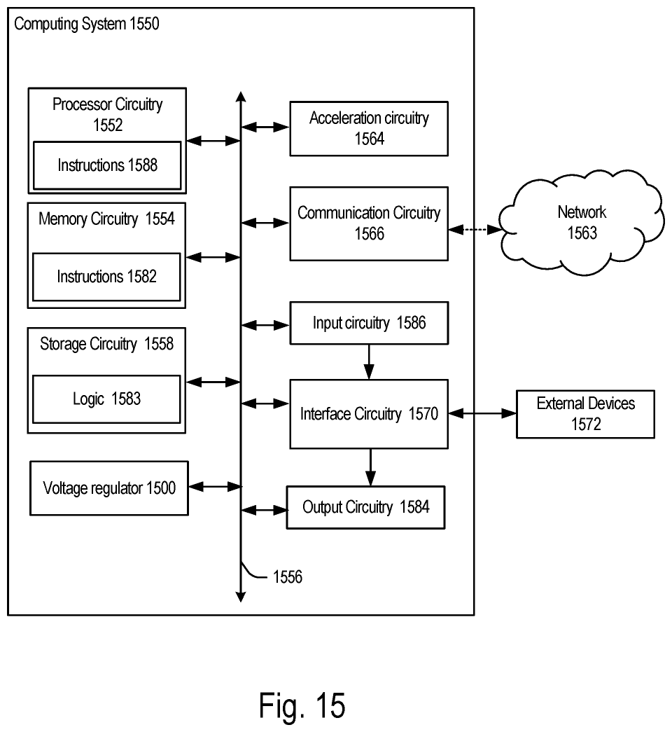

FIG. 15 illustrates an example of components that may be present in a computing system 1550 for implementing the techniques (e.g., operations, processes, methods, and methodologies) described herein.

The computing system 1550 may include any combinations of the hardware or logical components referenced herein. The components may be implemented as ICs, portions thereof, discrete electronic devices, or other modules, instruction sets, programmable logic or algorithms, hardware, hardware accelerators, software, firmware, or a combination thereof adapted in the computing system 1550, or as components otherwise incorporated within a chassis of a larger system.

In an example implementation, the voltage regulator 1500 represents any of the VR circuits 700, 800, 1000 or 1300. The processor circuitry 1552 may represent any of the control circuits 705, 1005 or 1305.

In one approach, all or part of the computing system 1550 is provided in a SoP, System in Package (SiP) or a System on Chip (SoC).

The voltage regulator can provide a voltage Vout to one or more of the components of the computing system 1550. The memory circuitry 1554 may store instructions and the processor circuitry 1552 may execute the instructions to perform the functions described herein.

The system 1550 includes processor circuitry in the form of one or more processors 1552. The processor circuitry 1552 includes circuitry such as, but not limited to one or more processor cores and one or more of cache memory, low drop-out voltage regulators (LDOs), interrupt controllers, serial interfaces such as SPI, I2C or universal programmable serial interface circuit, real time clock (RTC), timer-counters including interval and watchdog timers, general purpose I/O, memory card controllers such as secure digital/multi-media card (SD/MMC) or similar, interfaces, mobile industry processor interface (MIPI) interfaces and Joint Test Access Group (JTAG) test access ports. In some implementations, the processor circuitry 1552 may include one or more hardware accelerators (e.g., same or similar to acceleration circuitry 1564), which may be microprocessors, programmable processing devices (e.g., FPGA, ASIC, etc.), or the like. The one or more accelerators may include, for example, computer vision and/or deep learning accelerators. In some implementations, the processor circuitry 1552 may include on-chip memory circuitry, which may include any suitable volatile and/or non-volatile memory, such as DRAM, SRAM, EPROM, EEPROM, Flash memory, solid-state memory, and/or any other type of memory device technology, such as those discussed herein

The processor circuitry 1552 may include, for example, one or more processor cores (CPUs), application processors, GPUs, RISC processors, Acorn RISC Machine (ARM) processors, CISC processors, one or more DSPs, one or more FPGAs, one or more PLDs, one or more ASICs, one or more baseband processors, one or more radio-frequency integrated circuits (RFIC), one or more microprocessors or controllers, a multi-core processor, a multithreaded processor, an ultra-low-voltage processor, an embedded processor, or any other known processing elements, or any suitable combination thereof. The processors (or cores) 1552 may be coupled with or may include memory/storage and may be configured to execute instructions stored in the memory/storage to enable various applications or operating systems to run on the platform 1550. The processors (or cores) 1552 is configured to operate application software to provide a specific service to a user of the platform 1550. In some embodiments, the processor(s) 1552 may be a special-purpose processor(s)/controller(s) configured (or configurable) to operate according to the various embodiments herein.

As examples, the processor(s) 1552 may include an Intel® Architecture Core™ based processor such as an i3, an i5, an i7, an i9 based processor; an Intel® microcontroller-based processor such as a Quark™, an Atom™, or other MCU-based processor; Pentium® processor(s), Xeon® processor(s), or another such processor available from Intel® Corporation, Santa Clara, California. However, any number other processors may be used, such as one or more of Advanced Micro Devices (AMD) Zen® Architecture such as Ryzen® or EPYC® processor(s), Accelerated Processing Units (APUs), MxGPUs, Epyc® processor(s), or the like; A5-A12 and/or S1-S4 processor(s) from Apple® Inc., Snapdragon™ or Centriq™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; the ThunderX2® provided by Cavium™, Inc.; or the like. In some implementations, the processor(s) 1552 may be a part of a system on a chip (SoC), System-in-Package (SiP), a multi-chip package (MCP), and/or the like, in which the processor(s) 1552 and other components are formed into a single integrated circuit, or a single package, such as the Edison™ or Galileo™ SoC boards from Intel® Corporation. Other examples of the processor(s) 1552 are mentioned elsewhere in the present disclosure.

The system 1550 may include or be coupled to acceleration circuitry 1564, which may be embodied by one or more AI/ML accelerators, a neural compute stick, neuromorphic hardware, an FPGA, an arrangement of GPUs, one or more SoCs (including programmable SoCs), one or more CPUs, one or more digital signal processors, dedicated ASICs (including programmable ASICs), PLDs such as complex (CPLDs) or high complexity PLDs (HCPLDs), and/or other forms of specialized processors or circuitry designed to accomplish one or more specialized tasks. These tasks may include AI/ML processing (e.g., including training, inferencing, and classification operations), visual data processing, network data processing, object detection, rule analysis, or the like. In FPGA-based implementations, the acceleration circuitry 1564 may comprise logic blocks or logic fabric and other interconnected resources that may be programmed (configured) to perform various functions, such as the procedures, methods, functions, etc. of the various embodiments discussed herein. In such implementations, the acceleration circuitry 1564 may also include memory cells (e.g., EPROM, EEPROM, flash memory, static memory (e.g., SRAM, anti-fuses, etc.) used to store logic blocks, logic fabric, data, etc. in LUTs and the like.

In some implementations, the processor circuitry 1552 and/or acceleration circuitry 1564 may include hardware elements specifically tailored for machine learning and/or artificial intelligence (AI) functionality. In these implementations, the processor circuitry 1552 and/or acceleration circuitry 1564 may be, or may include, an AI engine chip that can run many different kinds of AI instruction sets once loaded with the appropriate weightings and training code. Additionally or alternatively, the processor circuitry 1552 and/or acceleration circuitry 1564 may be, or may include, AI accelerator(s), which may be one or more of the aforementioned hardware accelerators designed for hardware acceleration of AI applications. As examples, these processor(s) or accelerators may be a cluster of artificial intelligence (AI) GPUs, tensor processing units (TPUs) developed by Google® Inc., Real AI Processors (RAPS™) provided by AlphaICs®, Nervana™ Neural Network Processors (NNPs) provided by Intel® Corp., Intel® Movidius™ Myriad™ X Vision Processing Unit (VPU), NVIDIA® PX™ based GPUs, the NM500 chip provided by General Vision®, Hardware 3 provided by Tesla®, Inc., an Epiphany™ based processor provided by Adapteva®, or the like. In some embodiments, the processor circuitry 1552 and/or acceleration circuitry 1564 and/or hardware accelerator circuitry may be implemented as AI accelerating co-processor(s), such as the Hexagon 685 DSP provided by Qualcomm®, the PowerVR 2NX Neural Net Accelerator (NNA) provided by Imagination Technologies Limited®, the Neural Engine core within the Apple® A11 or A12 Bionic SoC, the Neural Processing Unit (NPU) within the HiSilicon Kirin provided by Huawei®, and/or the like. In some hardware-based implementations, individual subsystems of system 1550 may be operated by the respective AI accelerating co-processor(s), AI GPUs, TPUs, or hardware accelerators (e.g., FPGAs, ASICs, DSPs, SoCs, etc.), etc., that are configured with appropriate logic blocks, bit stream(s), etc. to perform their respective functions.

The system 1550 also includes system memory 1554. Any number of memory devices may be used to provide for a given amount of system memory. As examples, the memory 1554 may be, or include, volatile memory such as random access memory (RAM), static RAM (SRAM), dynamic RAM (DRAM), synchronous DRAM (SDRAM), RAMBUS® Dynamic Random Access Memory (RDRAM®), and/or any other desired type of volatile memory device. Additionally or alternatively, the memory 1554 may be, or include, non-volatile memory such as read-only memory (ROM), erasable programmable ROM (EPROM), electrically erasable programmable (EEPROM), flash memory, non-volatile RAM, ferroelectric RAM, phase-change memory (PCM), flash memory, and/or any other desired type of non-volatile memory device. Access to the memory 1554 is controlled by a memory controller. The individual memory devices may be of any number of different package types such as single die package (SDP), dual die package (DDP) or quad die package (Q17P). Any number of other memory implementations may be used, such as dual inline memory modules (DIMMs) of different varieties including but not limited to microDIMMs or MiniDIMMs.

Storage circuitry 1558 provides persistent storage of information such as data, applications, operating systems and so forth. In an example, the storage 1558 may be implemented via a solid-state disk drive (SSDD) and/or high-speed electrically erasable memory (commonly referred to as “flash memory”). Other devices that may be used for the storage 1558 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, a hard disk drive (HDD), micro HDD, of a combination thereof, and/or any other memory. The memory circuitry 1554 and/or storage circuitry 1558 may also incorporate three-dimensional (3D) cross-point (XPOINT) memories from Intel® and Micron®.

The memory circuitry 1554 and/or storage circuitry 1558 is/are configured to store computational logic 1583 in the form of software, firmware, microcode, or hardware-level instructions to implement the techniques described herein. The computational logic 1583 may be employed to store working copies and/or permanent copies of programming instructions, or data to create the programming instructions, for the operation of various components of system 1550 (e.g., drivers, libraries, application programming interfaces (APIs), etc.), an operating system of system 1550, one or more applications, and/or for carrying out the embodiments discussed herein. The computational logic 1583 may be stored or loaded into memory circuitry 1554 as instructions 1582, or data to create the instructions 1582, which are then accessed for execution by the processor circuitry 1552 to carry out the functions described herein. The processor circuitry 1552 and/or the acceleration circuitry 1564 accesses the memory circuitry 1554 and/or the storage circuitry 1558 over the interconnect (IX) 1556. The instructions 1582 direct the processor circuitry 1552 to perform a specific sequence or flow of actions, for example, as described with respect to flowchart(s) and block diagram(s) of operations and functionality depicted previously. The various elements may be implemented by assembler instructions supported by processor circuitry 1552 or high-level languages that may be compiled into instructions 1588, or data to create the instructions 1588, to be executed by the processor circuitry 1552. The permanent copy of the programming instructions may be placed into persistent storage devices of storage circuitry 1558 in the factory or in the field through, for example, a distribution medium (not shown), through a communication interface (e.g., from a distribution server (not shown)), over-the-air (OTA), or any combination thereof.

The IX 1556 couples the processor 1552 to communication circuitry 1566 for communications with other devices, such as a remote server (not shown) and the like. The communication circuitry 1566 is a hardware element, or collection of hardware elements, used to communicate over one or more networks 1563 and/or with other devices. In one example, communication circuitry 1566 is, or includes, transceiver circuitry configured to enable wireless communications using any number of frequencies and protocols such as, for example, the Institute of Electrical and Electronics Engineers (IEEE) 802.11 (and/or variants thereof), IEEE 802.23.4, Bluetooth® and/or Bluetooth® low energy (BLE), ZigBee®, LoRaWAN™ (Long Range Wide Area Network), a cellular protocol such as 3GPP LTE and/or Fifth Generation (5G)/New Radio (NR), and/or the like. Additionally or alternatively, communication circuitry 1566 is, or includes, one or more network interface controllers (NICs) to enable wired communication using, for example, an Ethernet connection, Controller Area Network (CAN), Local Interconnect Network (LIN), DeviceNet, ControlNet, Data Highway+, or PROFINET, among many others.

The IX 1556 also couples the processor 1552 to interface circuitry 1570 that is used to connect system 1550 with one or more external devices 1572. The external devices 1572 may include, for example, sensors, actuators, positioning circuitry (e.g., global navigation satellite system (GNSS)/Global Positioning System (GPS) circuitry), client devices, servers, network appliances (e.g., switches, hubs, routers, etc.), integrated photonics devices (e.g., optical neural network (ONN) integrated circuit (IC) and/or the like), and/or other like devices.

In some optional examples, various input/output (I/O) devices may be present within or connected to, the system 1550, which are referred to as input circuitry 1586 and output circuitry 1584. The input circuitry 1586 and output circuitry 1584 include one or more user interfaces designed to enable user interaction with the platform 1550 and/or peripheral component interfaces designed to enable peripheral component interaction with the platform 1550. Input circuitry 1586 may include any physical or virtual means for accepting an input including, inter alia, one or more physical or virtual buttons (e.g., a reset button), a physical keyboard, keypad, mouse, touchpad, touchscreen, microphones, scanner, headset, and/or the like. The output circuitry 1584 may be included to show information or otherwise convey information, such as sensor readings, actuator position(s), or other like information. Data and/or graphics may be displayed on one or more user interface components of the output circuitry 1584. Output circuitry 1584 may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Crystal Displays (LCD), LED displays, quantum dot displays, projectors, etc.), with the output of characters, graphics, multimedia objects, and the like being generated or produced from the operation of the platform 1550. The output circuitry 1584 may also include speakers and/or other audio emitting devices, printer(s), and/or the like. Additionally or alternatively, sensor(s) may be used as the input circuitry 1584 (e.g., an image capture device, motion capture device, or the like) and one or more actuators may be used as the output device circuitry 1584 (e.g., an actuator to provide haptic feedback or the like). Peripheral component interfaces may include, but are not limited to, a non-volatile memory port, a USB port, an audio jack, a power supply interface, etc. In some embodiments, a display or console hardware, in the context of the present system, may be used to provide output and receive input of an edge computing system; to manage components or services of an edge computing system; identify a state of an edge computing component or service; or to conduct any other number of management or administration functions or service use cases.

The components of the system 1550 may communicate over the IX 1556. The IX 1556 may include any number of technologies, including ISA, extended ISA, I2C, SPI, point-to-point interfaces, power management bus (PMBus), PCI, PCIe, PCIx, Intel® UPI, Intel® Accelerator Link, Intel® CXL, CAPI, OpenCAPI, Intel® QPI, UPI, Intel® OPA IX, RapidIO™ system IXs, CCIX, Gen-Z Consortium IXs, a HyperTransport interconnect, NVLink provided by NVIDIA®, a Time-Trigger Protocol (TTP) system, a FlexRay system, PROFIBUS, and/or any number of other IX technologies. The IX 1556 may be a proprietary bus, for example, used in a SoC based system.

The number, capability, and/or capacity of the elements of system 1550 may vary, depending on whether computing system 1550 is used as a stationary computing device (e.g., a server computer in a data center, a workstation, a desktop computer, etc.) or a mobile computing device (e.g., a smartphone, tablet computing device, laptop computer, game console, IoT device, etc.). In various implementations, the computing device system 1550 may comprise one or more components of a data center, a desktop computer, a workstation, a laptop, a smartphone, a tablet, a digital camera, a smart appliance, a smart home hub, a network appliance, and/or any other device/system that processes data.

The techniques described herein can be performed partially or wholly by software or other instructions provided in a machine-readable storage medium (e.g., memory). The software is stored as processor-executable instructions (e.g., instructions to implement any other processes discussed herein). Instructions associated with the flowchart (and/or various embodiments) and executed to implement embodiments of the disclosed subject matter may be implemented as part of an operating system or a specific application, component, program, object, module, routine, or other sequence of instructions or organization of sequences of instructions.

The storage medium can be a tangible, non-transitory machine readable medium such as read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs)), among others.

The storage medium may be included, e.g., in a communication device, a computing device, a network device, a personal digital assistant, a manufacturing tool, a mobile communication device, a cellular phone, a notebook computer, a tablet, a game console, a set top box, an embedded system, a TV (television), or a personal desktop computer.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), a combinational logic circuit, and/or other suitable hardware components that provide the described functionality. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well-known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus, comprising:
a clock generator to provide a baseline clock signal, a set of clock dividers with different division ratios coupled to the clock generator, and respective switches coupled to an output of respective clock dividers of the set of clock dividers;
a first stage voltage regulator (VR) coupled to the respective switches;
a second stage VR coupled to an output of the clock generator, wherein the second stage VR comprises a continuous capacitive VR;
a third stage VR coupled to the output of the clock generator; and
a circuit coupled to the third stage VR, wherein the circuit is coupled to the respective switches to select one of the respective switches, and the first stage VR is to receive a divided clock from one of the clock dividers based on the selected one of the respective switches.

2. The apparatus of claim 1, wherein the circuit is to select the one of the respective switches based on a selectable voltage down-conversion ratio of the third stage VR, and a frequency of the divided clock signal is a decreasing function of the selectable voltage down-conversion ratio.

3. The apparatus of claim 1, wherein the second stage VR and the third stage VR are to receive the baseline clock signal from the output of the clock generator.

4. The apparatus of claim 1, wherein the circuit is to select the one of the respective switches to provide a higher frequency for the divided clock signal when the second stage VR is operating in a boost mode than when the second stage VR is operating in a step down mode.

5. The apparatus of claim 1, further comprising:
an input node coupled to the circuit, the first stage VR and the second stage VR; and
wherein the circuit is to select the one of the respective switches based on a ratio between the output voltage and a voltage of the input node.

6. The apparatus of claim 1, wherein the circuit is to select the one of the respective switches to reduce a frequency of the divided clock as an output voltage of the third stage VR increases.

7. The apparatus of claim 1, wherein:
the third stage VR has different VR instances; and
at least one of the different VR instances is to transition from operating with a gapped version of the baseline clock signal to operating with a non-gapped version of the baseline clock signal when a current of a load which is coupled to an output voltage path of the third stage exceeds a threshold.

8. The apparatus of claim 7, wherein:
at least one other of the different VR instances continues to operate with a non-gapped version of the baseline clock signal as the current of the load which is coupled to the output voltage path of the third stage exceeds the threshold.

9. The apparatus of claim 1, wherein an output of the first stage VR is coupled to the second stage VR to provide an intermediate ground voltage to the second stage VR.

10. A system, comprising:
a processor; and
a voltage regulator circuit coupled to the processor, wherein the voltage regulator circuit comprises:
a continuous capacitive voltage regulator (C2VR) to receive an input voltage from an input node;
a voltage regulator (VR) to receive an output voltage from the C2VR, wherein the VR is to output an output voltage according to the output voltage from the C2VR and a voltage down-conversion ratio of the VR; and
a circuit coupled to the input node and to the VR, wherein the circuit is to decrease the voltage down-conversion ratio of the VR when the input voltage ramps down below a first threshold.

11. The system of claim 10, wherein the input voltage ramps down below the first threshold in a dynamic bypass mode in which the input voltage ramps down from an initial voltage to the output voltage of the VR.

12. The system of claim 11, wherein the C2VR is to transition from a step down mode to a boost mode when the input voltage ramps down below a second threshold.

13. The system of claim 12, wherein the second threshold is greater than the first threshold.

14. The system of claim 10, wherein the circuit is to shut off the C2VR and the VR when the input voltage reaches the output voltage of the VR.

15. The system of claim 10, wherein the voltage regulator circuit further comprises a VR to provide an intermediate ground voltage to the C2VR.

16. The system of claim 10, wherein the first threshold is a function of the voltage down-conversion ratio.

17. An apparatus, comprising:
a set of voltage regulator (VR) cells, wherein respective VR cells of the set of VR cells comprises a continuous capacitive voltage regulator (C2VR), one or more input VRs coupled to an input of the C2VR, and an output VR coupled to an output of the C2VR;
an input node coupled to an input of the one or more input VRs of the respective VR cells;
an intermediate voltage path coupled to an output of the C2VR of the respective VR cells and to an input of the output VR of each VR cell; and
an output voltage path coupled to an output of the output VR of the respective VR cells.

18. The apparatus of claim 17, further comprising a circuit to monitor a current of a load which is coupled to the output voltage path, wherein when the circuit determines that the current falls below a threshold, the circuit is to turn off the input VR and the C2VR for a subset of the VR cells while maintaining an on state for the respective output VRs.

19. The apparatus of claim 17, further comprising a circuit to monitor a current of a load which is coupled to the output voltage path, wherein the circuit is to turn on the input VR and the C2VR for a number of the VR cells, wherein the number is an increasing function of the current, while maintaining an on state for the respective output VRs.

20. The apparatus of claim 17, wherein the one or more input VRs are among a plurality of input VRs of the respective VR cells.
